(19) United States
(12) Patent Application Publication
(10) Pub. No.: US 2017/0282447 A1
(43) Pub. Date: Oct. 5, 2017

(54) METHOD OF MANUFACTURING A STABILIZER BAR WITH A RUBBER BUSH

(71) Applicant: Sumitomo Riko Company Limited, Komaki-shi (JP)

(72) Inventors: Yasuo Suzuki, Komaki-shi (JP); Takamitsu Hayashi, Komaki-shi (JP); Norimasa Kuki, Komaki-shi (JP); Ryusuke Yamada, Komaki-shi (JP); Ryusuke Ohnishi, Komaki-shi (JP)

(73) Assignee: Sumitomo Riko Company Limited, Komaki-shi (JP)

(21) Appl. No.: 15/446,104

(22) Filed: Mar. 1, 2017

(30) Foreign Application Priority Data
Mar. 29, 2016 (JP) 2016-065120

(51) Int. Cl. B29C 65/00; B29C 65/48; B60G 21/055

(52) U.S. Cl. CPC B29C 66/742; B60G 21/055; B29C 65/4835; B29C 66/24221; B60G 2204/41; B60G 2206/73; B60G 2206/80; B29L 2031/30

(57) ABSTRACT

Provided is a method of manufacturing a stabilizer bar with a rubber bush including manufacturing a rubber bush without an intermediate plate by subjecting a rubber composition containing butadiene rubber and natural rubber as a polymer to vulcanization molding; applying a thermosetting adhesive onto at least one of an inner peripheral surface of the rubber bush and an outer peripheral surface of the stabilizer bar, to thereby form a thermosetting adhesive layer; inserting and fitting the stabilizer bar into the rubber bush; holding the rubber bush with a fixing jig such that the rubber bush is compressed at a rate of 0% to 5%, at 25° C., in a direction of the stabilizer bar fitted into the rubber bush; and heating the rubber bush in the state to cure the thermosetting adhesive, to thereby bond and fix the rubber bush onto the stabilizer bar.

### TECHNICAL FIELD

The present disclosure relates to a method of manufacturing a stabilizer bar with a rubber bush.

### BACKGROUND ART

A stabilizer bar, which is a part of a suspension device for vehicles such as an automobile, exhibits anti-vibration performance in combination with a rubber bush. As illustrated in FIG. 1, a rubber bush 3 has a tubular shape, and a stabilizer bar 1 is inserted and held into the tube. As such stabilizer bar with a rubber bush, a non-bonded type in which the stabilizer bar 1 and the rubber bush 3 are not bonded onto each other has hitherto been in the mainstream. However, in recent years, a bonded type in which the stabilizer bar 1 and the rubber bush 3 are bonded onto each other is becoming the mainstream although the product price is higher. The reason for this is as follows. A gap is not formed between the stabilizer bar 1 and the rubber bush 3 by bonding the stabilizer bar 1 and the rubber bush 3 onto each other. Therefore, anti-vibration performance is enhanced, and further, the problem of occurrence of squeak noise due to the entry of water or dust into the gap can also be solved. Particularly in expensive cars, when the squeak noise is transmitted to a driver to give a discomfort feeling to the driver, a product value may be significantly influenced. Thus, the solution to the squeak noise is listed as an important item.

As a procedure for bonding the rubber bush 3 onto the stabilizer bar 1, there are given, for example, a vulcanization bonding process involving simultaneously performing vulcanization molding of the rubber bush 3 and bonding of the rubber bush 3 onto the stabilizer bar 1, and a post-bonding process involving bonding the rubber bush 3 obtained by vulcanization molding onto the stabilizer bar 1. The vulcanization bonding process is more suitable for enhancing adhesiveness as compared to the post-bonding process. However, when bonding of the mass-produced rubber bush 3 onto the stabilizer bar 1 is considered, the post-bonding process is more excellent in productivity. The post-bonding process generally involves applying a thermosetting adhesive onto at least one of an inner peripheral surface of the rubber bush 3 and an outer peripheral surface of the stabilizer bar 1, inserting and fitting the stabilizer bar 1 into the rubber bush 3, heating the resultant while applying a high pressure at a compression rate of 5% or more onto the rubber bush 3 to cure the thermosetting adhesive, to thereby bond the rubber bush 3 onto the stabilizer bar 1 (see JP-A-2001-270315 and JP-A-2006-8082).

### RELATED ART DOCUMENT

### Patent Document

PTL 1: JP-A-2001-270315

PTL 2: JP-A-2006-8082

### SUMMARY OF INVENTION

As the above-mentioned rubber bush, a rubber bush containing only natural rubber as a polymer is generally used. However, the heat condition under the usage environment is severe, and hence the change into a rubber bush using a mixed polymer of butadiene rubber and natural rubber has been investigated in order to suppress settling caused by heat.

However, when butadiene rubber is used as a polymer of the rubber bush, there is a problem in that, after the rubber bush is post-bonded onto the stabilizer bar, bonding abnormalities, such as an interfacial peeling between the rubber bush and the thermosetting adhesive layer and cohesive failure of the thermosetting adhesive layer, occur, and hence the bonding is not stabilized. The reason for this is considered as follows. The rubber bush using a mixed polymer of butadiene rubber and natural rubber has a larger thermal expansion coefficient as compared to that of the rubber bush containing only natural rubber as a polymer. Because of this, a load is liable to be applied onto a bonding interface between the rubber bush and the stabilizer bar as compared to the case where the rubber bush containing only natural rubber as a polymer is used, and the load is liable to cause the above-mentioned problem of adhesiveness.

Further, as disclosed in, for example, JP-A-2006-8082, the problem of adhesiveness has also been investigated by inserting an insert material, such as an intermediate plate, made of a metal or the like into the rubber bush, to thereby structurally suppress rubber deformation at the bonding interface between the stabilizer bar and the rubber bush. However, the intermediate plate is not desired for enhancing the degree of freedom in design and reducing cost, and hence there is a demand for a solution to the problem of adhesiveness without use of such intermediate plate.

The present disclosure has been made in view of the above-mentioned circumstances, and discloses a method of manufacturing a stabilizer bar with a rubber bush capable of realizing stable adhesiveness when a rubber bush using a mixed polymer of butadiene rubber and natural rubber is post-bonded onto a stabilizer bar.

According to one aspect of the present disclosure, there is provided a method of manufacturing a stabilizer bar with a rubber bush in which the stabilizer bar is inserted and held into the rubber bush, the method including:

a first step of manufacturing a rubber bush without an intermediate plate by subjecting a rubber composition containing butadiene rubber and natural rubber as a polymer to vulcanization molding;

a second step of applying a thermosetting adhesive onto at least one of an inner peripheral surface of the rubber bush and an outer peripheral surface of the stabilizer bar, to thereby form a thermosetting adhesive layer;

a third step of inserting and fitting the stabilizer bar into the rubber bush;

a fourth step of holding the rubber bush with a fixing jig such that the rubber bush is compressed in a direction of the stabilizer bar fitted into the rubber bush at a rate of 0% to 5%, at 25° C.; and

a fifth step of heating the rubber bush to cure the thermosetting adhesive, while holding the rubber bush with the fixing jig such that the rubber bush is compressed in the direction of the stabilizer bar fitted into the rubber bush at the rate of 0% to 5%, to thereby bond and fix the rubber bush onto the stabilizer bar.

That is, in a stabilizer bar with a rubber bush obtained by post-bonding a rubber bush using a mixed polymer of butadiene rubber and natural rubber onto a stabilizer bar, bonding peeling occurs in a portion in which deformation of the rubber bush is large in a bonding step with a thermosetting adhesive during a heating reaction of an adhesive. As described above, in the rubber bush containing only natural rubber as a polymer, the following has hitherto been performed. A thermosetting adhesive is applied onto at least one of an inner peripheral surface of the rubber bush and an outer peripheral surface of the stabilizer bar. The stabilizer bar is inserted and fitted into the rubber bush, and the resultant is heated while a high pressure at a compression rate of 5% or more is applied onto the rubber bush to cure the thermosetting adhesive, to thereby bond the rubber bush onto the stabilizer bar. This is because, when a high pressure is applied onto the rubber bush, the stabilizer bar can be fixed with the return compression force of the rubber bush. It has been considered as common general technical knowledge to enhance the adhesiveness between the rubber bush and the stabilizer bar through application of a high pressure. However, when this bonding method was applied to the post-bonding of the rubber bush using a mixed polymer of butadiene rubber and natural rubber, the rubber bush was significantly deformed due to the high pressure, and bonding peeling occurred in that portion. Further, when the rubber bush using a mixed polymer of butadiene rubber and natural rubber and the stabilizer bar were post-bonded onto each other merely with a thermosetting adhesive without performing the above-mentioned pressurization, stable bonding was not realized. It is important to suppress rubber deformation occurring at a bonding interface in accordance with a rubber material in order to realize the above-mentioned stable post-bonding of the rubber bush onto the stabilizer bar. The large thermal expansion coefficient of the rubber bush using a mixed polymer of butadiene rubber and natural rubber is used for stabilizing the bonding of the rubber bush onto the stabilizer bar. Specifically, in a state in which the stabilizer bar having the thermosetting adhesive applied thereto was inserted and fitted into the rubber bush, the rubber bush was held with a fixing jig such that the rubber bush is compressed in a direction of the stabilizer bar fitted into the rubber bush at a rate of 0% to 5%, at 25° C., to thereby fix the periphery of a bonding portion without deformation or enlargement, and the resultant was heated in the fixed state to cure the thermosetting adhesive and accelerate the thermal expansion of the rubber bush. A surface pressure having small strain is ensured with the pressure resulting from the thermal expansion of the rubber bush, and consequently, stable adhesiveness can be realized while rubber deformation is suppressed, with the result that the common general technical knowledge that has hitherto been accepted is overturned.

As described above, the method of manufacturing a stabilizer bar with a rubber bush of the present disclosure includes: a first step of manufacturing a rubber bush without an intermediate plate by subjecting a rubber composition containing butadiene rubber and natural rubber as a polymer to vulcanization molding; a second step of applying a thermosetting adhesive onto at least one of an inner peripheral surface of the rubber bush and an outer peripheral surface of the stabilizer bar, to thereby form a thermosetting adhesive layer; a third step of inserting and fitting the stabilizer bar into the rubber bush; a fourth step of holding the rubber bush with a fixing jig such that the rubber bush is compressed in a direction of the stabilizer bar fitted into the rubber bush at a rate of 0% to 5%, at 25° C.; and a fifth step of heating the rubber bush to cure the thermosetting adhesive, wherein the rubber bush with the fixing jig such that the rubber bush is compressed in the direction of the stabilizer bar fitted into the rubber bush at the rate of 0% to 5%, to thereby bond and fix the rubber bush onto the stabilizer bar. Therefore, when the rubber bush using a mixed polymer of butadiene rubber and natural rubber is post-bonded onto the stabilizer bar as described above, stable adhesiveness can be realized. Further, the rubber bush containing butadiene rubber having less settling caused by heat can be subjected to post-bonding, and hence the degree of freedom in design of the rubber bush can be enhanced. Further, stable adhesiveness can be realized even when the intermediate plate of the rubber bush is eliminated, and hence the effects of reduction in manufacturing cost and reduction in weight based on the elimination of the intermediate plate, and enhancement of fuel consumption of an automobile based on the reduction in weight are attained.

In particular, when the rubber bush is formed of a rubber composition containing butadiene rubber (BR) and natural rubber (NR) at a weight ratio BR/NR of from 4/6 to 1/9, preferably at a weight ratio BR/NR of from 3/7 to 2/8, the balance between the resistance to settling caused by heat and the anti-vibration properties is improved.

Further, when the second step includes applying an undercoat thermosetting adhesive onto the outer peripheral surface of the stabilizer bar and applying a topcoat thermosetting adhesive onto the undercoat thermosetting adhesive, the bonding stability between the stabilizer bar and the rubber bush is improved.

Further, when the fixing jig has a structure in which the fixing jig covers an entire outer peripheral surface of the rubber bush, the pressure resulting from the thermal expansion of the rubber bush is more easily transmitted to the stabilizer bar, with the result that more stable adhesiveness can be obtained.

### BRIEF DESCRIPTION OF DRAWINGS

FIG. 1 is a perspective view of a stabilizer bar with a rubber bush and a bracket.

FIG. 2 is a front view of a first pressing tool and a second pressing tool.

FIG. 3 is a side view of the first pressing tool and the second pressing tool.

FIG. 4 is an explanatory view for illustrating a state in which the rubber bush is fitted into the first pressing tool and the second pressing tool.

### DESCRIPTION OF EMBODIMENTS

Embodiments of the present disclosure are hereinafter described in detail. However, the present disclosure is not limited to these embodiments.

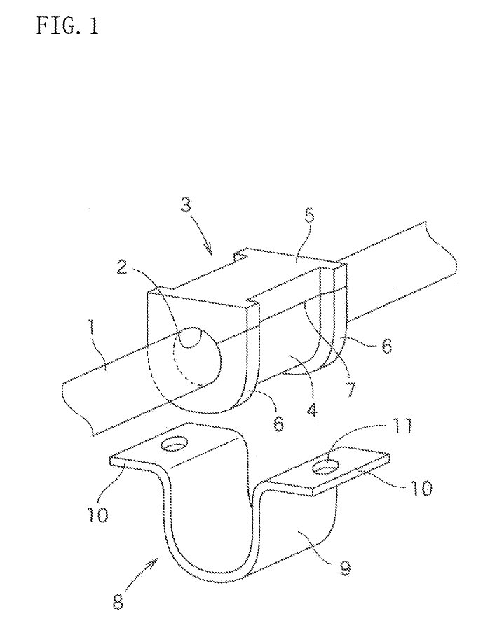

FIG. 1 is an example of a stabilizer bar with a rubber bush obtained by a manufacturing method of the present disclosure and a bracket configured to press and fix the rubber bush onto a vehicle body side of an automobile. In FIG. 1, there are illustrated a stabilizer bar 1, and a rubber bush 3 that is externally fitted and fixed onto a portion to be fitted 2 of the stabilizer bar 1. The stabilizer bar 1 has a round bar shape made of a metal, and the surface thereof is generally subjected to powder coating or cationic electrodeposition coating for the purpose of rust prevention. Further, in FIG. 1, the rubber bush 3 is formed into a tubular shape including a U-shaped outer peripheral surface 4 and a straight flat surface 5 connected to both ends of the U-shaped outer peripheral surface 4, and flanges 6 are respectively formed in both end portions of the rubber bush 3 in an axial direction. A cut portion 7 for mounting is formed in a radial direction and the axial direction.

A bracket 8 illustrated in FIG. 1 is externally fitted onto the rubber bush 3 and is used for bringing the flat surface 5 of the rubber bush 3 into pressure contact with a mounting surface of a vehicle body to fix the flat surface 5 onto the mounting surface. The bracket 8 includes a U-shaped rubber bush receiver 9 onto which the U-shaped outer peripheral surface 4 between the flanges 6 of the rubber bush 3 is internally fitted, and mounting pieces 10 each extending on the lateral outer side from both opened ends of the rubber bush receiver 9. A bolt insertion hole 11 is formed in each mounting piece 10.

As described above, the method of manufacturing a stabilizer bar with a rubber bush of the present disclosure includes: a first step of manufacturing a rubber bush without an intermediate plate by subjecting a rubber composition containing butadiene rubber and natural rubber as a polymer to vulcanization molding; a second step of applying a thermosetting adhesive onto at least one of an inner peripheral surface of the rubber bush and an outer peripheral surface of the stabilizer bar, to thereby form a thermosetting adhesive layer; a third step of inserting and fitting the stabilizer bar into the rubber bush; a fourth step of holding the rubber bush with a fixing jig such that the rubber bush is compressed in a direction of the stabilizer bar fitted into the rubber bush at a rate of 0% to 5%, at 25° C.; and a fifth step of heating the rubber bush to cure the thermosetting adhesive, while holding the rubber bush with the fixing jig such that the rubber bush is compressed in the direction of the stabilizer bar fitted into the rubber bush at the rate of 0% to 5%, to thereby bond and fix the rubber bush onto the stabilizer bar.

In the first step, a rubber bush without an intermediate plate is manufactured by subjecting a rubber composition containing butadiene rubber and natural rubber as a polymer to vulcanization molding. There is no particular limitation on the shape of the rubber bush as long as a hole for holding the stabilizer bar is formed as illustrated in FIG. 1. Further, when the rubber composition contains butadiene rubber (BR) and natural rubber (NR) at a weight ratio BR/NR of from 4/6 to 1/9, preferably at a weight ratio BR/NR of from 3/7 to 2/8, the balance between the resistance to settling caused by heat and the anti-vibration properties is improved. When the amount of butadiene rubber is too large, that is, the amount of natural rubber is too small, the desired anti-vibration property is not easily obtained. When the amount of butadiene rubber is too small, that is, the amount of natural rubber is too large, the desired resistance to settling is not easily obtained.

Further, a vulcanizing agent, a vulcanization accelerator, a vulcanization aid, an antioxidant, a filler, such as carbon black, process oil, and the like may be blended in the rubber composition as necessary besides the polymer such as butadiene rubber and natural rubber.

The rubber bush without an intermediate plate is manufactured by subjecting a rubber composition obtained by kneading each of the above-mentioned materials for vulcanization molding. The molding is performed by heating the rubber composition at from 150° C. to 190° C. for from 5 minutes to 30 minutes.

The second step includes applying a thermosetting adhesive onto at least one of an inner peripheral surface of the rubber bush thus obtained and an outer peripheral surface of the stabilizer bar, to thereby form a thermosetting adhesive layer. In particular, it is preferred that this step include applying an undercoat thermosetting adhesive onto the outer peripheral surface of the stabilizer bar and applying a topcoat thermosetting adhesive onto the undercoat thermosetting adhesive, because the bonding stability between the stabilizer bar and the rubber bush is improved. The thermosetting adhesive is applied by spraying or the like, and then is naturally dried to form a thermosetting adhesive layer. When both the topcoat thermosetting adhesive and the undercoat thermosetting adhesive are used, the undercoat thermosetting adhesive is applied and naturally dried, and then the topcoat thermosetting adhesive is applied onto the undercoat thermosetting adhesive. The resultant is naturally dried again to form a topcoat thermosetting adhesive layer and an undercoat thermosetting adhesive layer.

Examples of the thermosetting adhesive include an epoxy-based adhesive, an acrylic adhesive, a urethane-based adhesive, a chlorinated rubber-based adhesive, a resin-based adhesive, and a polyolefin-based adhesive. Further, when both the topcoat thermosetting adhesive and the undercoat thermosetting adhesive are used as described above, for example, a polyolefin-based adhesive is preferably used as the topcoat thermosetting adhesive, and for example, a chlorinated rubber-based adhesive is preferably used as the undercoat thermosetting adhesive.

It is preferred that the thickness of the thermosetting adhesive layer preferably fall within a range of from 20 μm to 30 μm when the thermosetting adhesive layer is a single layer. When both the topcoat thermosetting adhesive and the undercoat thermosetting adhesive are used, it is preferred that the thickness of the topcoat thermosetting adhesive layer fall within a range of from 15 μm to 20 μm, and the thickness of the undercoat thermosetting adhesive layer fall within a range of from 5 μm to 10 μm.

Following the second step, the third step includes inserting and fitting the stabilizer bar 1 into the rubber bush 3. As illustrated in FIG. 1, the cut portion 7 of the rubber bush 3 obtained by the vulcanization molding may be opened to externally fit the rubber bush 3 onto the portion to be fitted 2, to thereby insert and fit the stabilizer bar 1 into the rubber bush 3. Further, the thermosetting adhesive layer formed in the second step is naturally interposed at the interface between the rubber bush 3 and the stabilizer bar 1.

The fourth step includes holding the rubber bush 3 with a fixing jig such that the rubber bush is compressed in a direction of the stabilizer bar 1 fitted into the rubber bush 3 at a rate of 0% to 5%, at 25° C. The fifth step to be performed following the fourth step includes heating the rubber bush 3 to cure the thermosetting adhesive, while holding the rubber bush such that the rubber bush is compressed at the rate of 0% to 5%, at 25° C., to thereby bond and fix the rubber bush 3 onto the stabilizer bar 1. The compression rate refers to a ratio of the thickness of the rubber bush 3 compressed with the fixing jig with respect to the 100% thickness of the rubber bush 3 in a non-compressed state. That is, the compression rate is determined based on the dimensions of the rubber bush 3 before being heated and the dimensions set with the fixing jig.

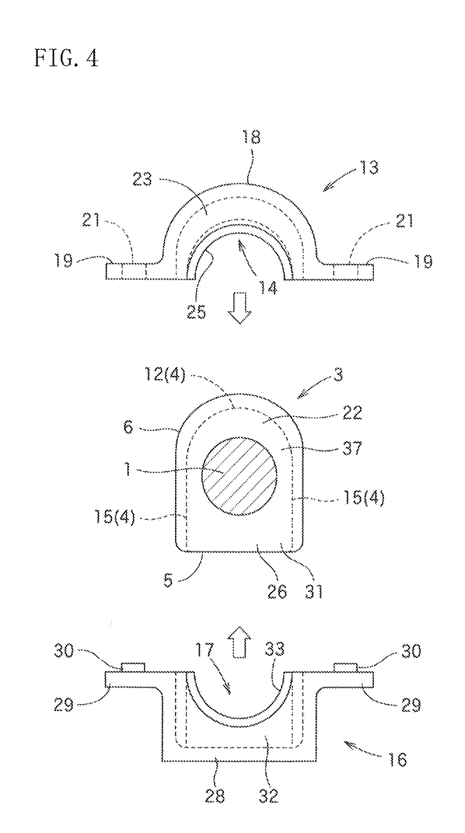

The fourth and fifth steps are specifically performed as follows. That is, as illustrated in FIG. 4, a first fitting recessed portion 14 of a first pressing tool 13 is externally fitted onto a protruding curved surface 12 of the U-shaped outer peripheral surface 4, and a second fitting recessed portion 17 of a second pressing tool 16 is externally fitted onto the flat surface 5 and a straight surface 15 of the U-shaped outer peripheral surface 4. Then, the rubber bush 3 is held by being sandwiched between the first pressing tool 13 and the second pressing tool 16 so that the rubber bush 3 is brought into a state of being compressed at a rate of 0% to 5%, at 25° C., and is heated in this state. After that, the first pressing tool 13 and the second pressing tool 16 are removed to provide a stabilizer bar with a rubber bush. It is preferred that the heating temperature be from 150° C. to 180° C., and the heating time be from 1 hour to 2 hours. This is because, when the rubber bush 3 is heated under the above-mentioned condition, curing of the thermosetting adhesive and the thermal expansion of the rubber bush 3 are accelerated, and a surface pressure having small strain is ensured with the pressure resulting from the thermal expansion of the rubber bush 3, with the result that stable adhesiveness can be realized while rubber deformation is suppressed. From the viewpoint of the stable adhesiveness, the thermal expansion coefficient of the rubber bush 3 at the above-mentioned heating temperature falls within a range of preferably from 1.9×10⁻⁴ K⁻¹ to 2.4×10⁻⁴ K⁻¹, more preferably from 2.0×10⁻⁴ K⁻¹ to 2.2×10⁻⁴ K⁻¹. Further, the first pressing tool 13 and the second pressing tool 16 serve as the fixing jig in the fourth and fifth steps.

The first pressing tool 13 and the second pressing tool 16 may be used as brackets configured to fix the rubber bush 3 onto a vehicle body side of an automobile without being removed from the stabilizer bar with a rubber bush. When the first pressing tool 13 and the second pressing tool 16 are not removed from the rubber bush 3, it is preferred, from the viewpoint of anti-vibration property and the like, that the fourth and fifth steps be performed after a thermosetting adhesive layer is formed also at an interface between the rubber bush 3 and the first pressing tool 13 and the second pressing tool 16. In this case, the step of forming the thermosetting adhesive layer at the interface between the rubber bush 3 and the first pressing tool 13 and the second pressing tool 16 is performed pursuant to the second step.

Further, although the first pressing tool 13 and the second pressing tool 16 are used as the fixing jig in the fourth and fifth steps of FIG. 4, a general mold may also be used as the fixing jig. Further, the bracket 8 as illustrated in FIG. 1 may also be used as the fixing jig.

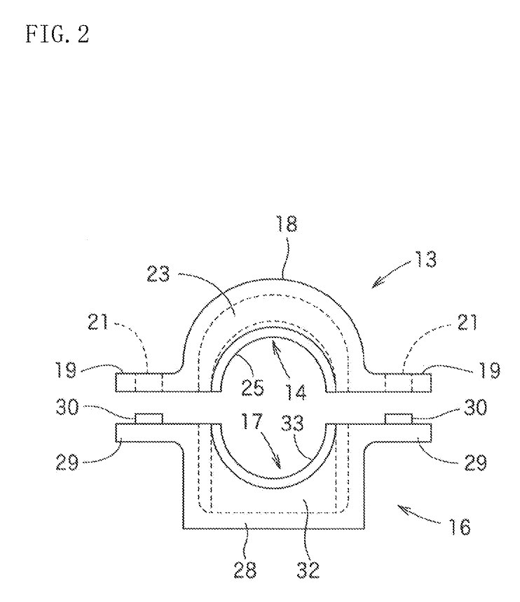

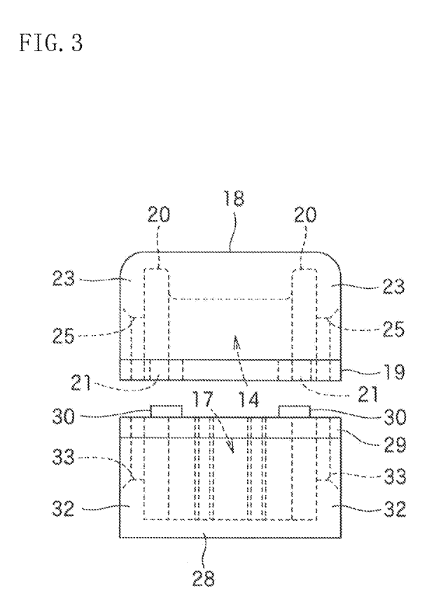

As illustrated in FIG. 2 and FIG. 3, the first pressing tool 13 includes a first accommodating portion 18 having a U-shaped cross-section configured to accommodate a protruding curved portion 37 (see FIG. 4) of the rubber bush 3 and a pair of first mounting plates 19 extending on the lateral outer side from both opened ends of the first accommodating portion 18. The first fitting recessed portion 14 is formed in the first accommodating portion 18. The first fitting recessed portion 14 is externally fitted onto the protruding curved surface 12. A pair of flange receivers 20 configured to accommodate the pair of flanges 6 of the rubber bush 3 respectively are formed in the first fitting recessed portion 14. A pair of through holes 21 is formed in the first mounting plates 19, and a pair of first side walls 23 covering both end surfaces 22 of the protruding curved portion 37 in the axial direction are formed respectively in both end portions of the first pressing tool 13 in the axial direction. A semicircular recessed portion 25 configured to receive the stabilizer bar 1 is formed in the first side wall 23.

Further, as illustrated in FIG. 2 and FIG. 3, the second pressing tool 16 includes a second accommodating portion 28 having a square U-shaped cross-section configured to accommodate a square block portion 26 of the rubber bush 3 (see FIG. 4; rubber bush portion having an outer peripheral surface that includes the flat surface 5 and the straight surface 15 of the U-shaped outer peripheral surface 4) and a pair of second mounting plates 29 extending on the lateral outer side from both opened ends of the second accommodating portion 28. The second fitting recessed portion 17 is formed in the second accommodating portion 28. The second fitting recessed portion 17 is externally fitted onto the flat surface 5 and the straight surface 15 of the U-shaped outer peripheral surface 4. A pair of pins 30 entering the pair of through holes 21 of the first mounting plate 19 respectively is formed on the second mounting plate 29 so as to protrude therefrom. A pair of second side walls 32 covering both end surfaces 31 of the square block portion 26 in the axial direction are formed respectively in both end portions of the second pressing tool 16 in the axial direction, and a semicircular recessed portion 33 configured to receive the stabilizer bar 1 is formed in the second side wall 32. The end surface 31 of the square block portion 26 is connected to the end surface 22 of the protruding curved portion 37 without any step.

The pair of pins 30 of the second pressing tool 16 enter the pair of through holes 21 of the first pressing tool 13 respectively in a state in which the rubber bush 3 is compressed by being sandwiched between the first pressing tool 13 and the second pressing tool 16. Further, substantially the entire surface of the rubber bush 3 is covered with the first fitting recessed portion 14 and the second fitting recessed portion 17. When the fixing jig in the fourth and fifth steps has a structure in which the fixing jig covers the entire outer peripheral surface of the rubber bush 3 as in the first pressing tool 13 and the second pressing tool 16, the pressure resulting from the thermal expansion of the rubber bush 3 is more easily transmitted to the stabilizer bar 1, and more stable adhesiveness can be obtained.

The stabilizer bar with a rubber bush thus manufactured may be suitably used as an anti-vibration device in automobiles and transportation equipment, such as industrial transportation vehicles, such as an airplane, a forklift, a loading shovel, and a crane, and may also be utilized as an anti-vibration device to be used in other industrial machines.

### EXAMPLES

Next, Examples are described together with Comparative Examples and Reference Examples. However, the present invention is not limited to these Examples.

### Example 1

First, 100 parts by mass (hereinafter abbreviated as “parts”) of a polymer obtained by blending butadiene rubber (BR) and natural rubber (NR) at a weight ratio BR/NR of 20/80, 5 parts of a vulcanization aid, 5 parts of an antioxidant, 80 parts of carbon black, 3 parts of a vulcanization accelerator, and 1 part of a vulcanizing agent were kneaded to prepare a rubber composition. Then, the rubber composition thus prepared was filled into a mold and subjected to vulcanization molding by heating at 150° C. for 30 minutes, to thereby manufacture a rubber bush having an inner diameter of 25 me without an intermediate plate.

Next, a chlorinated rubber-based adhesive was applied as an undercoat thermosetting adhesive onto an outer peripheral surface of a stabilizer bar, which was subjected to powder coating, having an outer diameter of 25 mm and naturally dried. Then, a polyolefin-based adhesive was applied as a topcoat thermosetting adhesive onto the undercoat thermosetting adhesive, and the resultant was naturally dried again, to thereby form an undercoat thermosetting adhesive layer having a thickness of 10 μm and a topcoat thermosetting adhesive layer having a thickness of 20 μm.

Then, the stabilizer bar was inserted and fitted into the rubber bush. After that, the rubber bush was compressed by being sandwiched between a first pressing tool and a second pressing tool as illustrated in FIG. 4. The rubber bush was heated at 170° C. for 2 hours in a state in which the rubber bush was compressed at a compression rate of 0% at 25° C. to cure the thermosetting adhesive. Then, the first pressing tool and the second pressing tool were removed to provide a stabilizer bar with a rubber bush.

The “compression rate of 0%” refers to the situation in which an outer peripheral surface of the rubber bush before being heated is held in contact with inner peripheral surfaces (fitting recessed portions) of the first pressing tool and the second pressing tool in a non-compressed state at 25° C.

### Examples 2 to 4, Comparative Examples 1 to 4, and Reference Examples 1 to 4

A stabilizer bar with a rubber bush was manufactured in the same manner as in Example 1 except that the weight ratio between butadiene rubber (BR) and natural rubber (NR) in a polymer of the rubber composition serving as a material of the rubber bush was set to values shown in Tables 1 to 3 described later, and the compression rate at 25° C. when the rubber bush was compressed by being sandwiched between the first pressing tool and the second pressing tool, before being heated, was set to values shown in Tables 1 to 3 described later.

The compression rate refers to a ratio of the thickness of the rubber bush compressed with the first pressing tool and the second pressing tool with respect to the 100% thickness of the rubber bush in a non-compressed state and is determined based on the dimensions of the rubber bush before being heated and the dimensions of the inner peripheral surfaces, that is, fitting recessed portions, of the first pressing tool and the second pressing tool. Further, the “compression rate of 0%” shown in the tables refers to the situation in which the outer peripheral surface of the rubber bush before being heated is held in contact with the inner peripheral surfaces, that is, fitting recessed portions, of the first pressing tool and the second pressing tool in a non-compressed state.

The stabilizer bars with rubber bushes of Examples and the like thus obtained were evaluated for bonding property of the rubber bush and the stabilizer bar in accordance with the following criteria. The results are shown in Tables 1 to 3 described later.

<<Bonding Property>

First, a rubber sheet having a thickness of 10 mm was manufactured through use of the same materials as those of the rubber bush of Examples under the same heating conditions as those of Examples. Next, the same undercoat thermosetting adhesive as that of Examples was applied onto an iron plate by spraying and naturally dried, to thereby form an undercoat thermosetting adhesive layer having a thickness of 10 μm. After that, the same topcoat thermosetting adhesive as that of Examples and the like was applied onto the undercoat thermosetting adhesive layer by spraying, and the resultant was naturally dried, to thereby form a topcoat thermosetting adhesive layer having a thickness of 20 μm. Then, the rubber sheet manufactured in the foregoing was laminated on the topcoat thermosetting adhesive layer. The rubber sheet was fixed in a state of being compressed on the iron plate side at a compression rate at a compression rate at 25° C. shown in Tables 1 to 3 described later and heated at 170° C. for 2 hours in the compressed state, to thereby cure the thermosetting adhesive. After that, the compressed state was released, and the rubber sheet was bonded onto the iron plate, to thereby provide a sample for evaluating bonding property of Examples.

Then, an end portion of the rubber sheet in the sample for evaluating bonding property was peeled and pulled toward an opposite side to the iron plate at a speed of 50 nm/minute through use of Strograph (manufactured by Toyoseiki Co., Ltd.), and thus peeling of the rubber sheet from the iron plate was performed. The state of the peeled surface in this case was visually evaluated, and the entire peeled surface was determined for a ratio (t) of an area falling under the following remarks (R, RC, CC). Then, the peeled surface that was R100% was determined to be “OK”, and the peeled surface that was not R100% was considered to suffer from abnormal peeling and determined to be “NG”. Regarding the peeled surface determined to be “OK”, the bonding strength (N/mm) during the above-mentioned peeling was measured with Strograph (manufactured by Toyoseiki Co., Ltd.).

R: Breakage of rubber sheet (broken material)

RC: Interfacial peeling between rubber sheet and topcoat thermosetting adhesive layer

CC: Breakage of topcoat thermosetting adhesive layer

TABLE 1

| | | Compression | | | |
|---|---|---|---|---|---|
| | BR/NR | rate at | Bonding | State of | |
| | (weight | 25° C. | strength | peeled | Deter- |
| | ratio) | (%) | (N/mm) | surface | mination |
| Example 1 | 20/80 | 0% | 6.0 N/mm | R100% | OK |
| Example 2 | 20/80 | 4% | 5.4 N/mm | R100% | OK |
| Comparative | 20/80 | 7% | — | R30%, | NG |
| Example 1 | | | | RC55%, | |
| | | | | CC15% | |
| Comparative | 20/80 | 10% | — | R20%, | NG |
| Example 2 | | | | RC80% | |

TABLE 2

| | | Compression | | | |
|---|---|---|---|---|---|
| | BR/NR | rate at | Bonding | State of | |
| | (weight | 25° C. | strength | peeled | Deter- |
| | ratio) | (%) | (N/mm) | surface | mination |
| Example 3 | 30/70 | 0% | 5.3 N/mm | R100% | OK |
| Example 4 | 30/70 | 4% | 5.2 N/mm | R100% | OK |
| Comparative | 30/70 | 7% | — | R10%, | NG |
| Example 3 | | | | RC30%, | |
| | | | | CC60% | |
| Comparative | 30/70 | 10% | — | R10%, | NG |
| Example 4 | | | | RC30%, | |
| | | | | CC60% | |

TABLE 3

| | | Compression | | | |
|---|---|---|---|---|---|
| | BR/NR | rate at | Bonding | State of | |
| | (weight | 25° C. | strength | peeled | |
| | ratio) | (%) | (N/mm) | surface | Determination |
| Reference | 0/100 | 0% | — | R80%, | NG |
| Example 1 | | | | RC20% | |
| Reference | 0/100 | 4% | 6.6 N/mm | R100% | OK |
| Example 2 | | | | | |
| Reference | 0/100 | 7% | 7.3 N/mm | R100% | OK |
| Example 3 | | | | | |
| Reference | 0/100 | 10% | 7.4 N/mm | R100% | OK |
| Example 4 | | | | | |

As is apparent from the evaluation results of Examples and Comparative Examples in Tables 1 and 2, the following is understood. In order to realize stable adhesiveness when the rubber bush using a mixed polymer of butadiene rubber and natural rubber is post-bonded to the stabilizer bar, it is preferred that the rubber bush be heated to cure the thermosetting adhesive, while holding the rubber bush with the fixing jig such that the rubber bush is compressed in a direction of the stabilizer bar which is an iron plate at a rate of 0% to 5%, at 25° C., to thereby bond and fix the rubber bush onto the stabilizer bar.

It is understood that, when the rubber bush containing only natural rubber as a polymer is post-bonded onto the stabilizer bar as in the related art, stable adhesiveness can be realized at a higher compression rate as shown in Reference Examples 1 to 4 of Table 3.

Although specific forms of embodiments of the instant invention have been described above in order to be more clearly understood, the above description is made by way of example and not as a limitation to the scope of the instant invention. It is contemplated that various modifications apparent to one of ordinary skill in the art could be made without departing from the scope of the invention.

The method of manufacturing a stabilizer bar with a rubber bush of the present disclosure can be performed preferably as a method of manufacturing a stabilizer bar with a rubber bush that can be used as an anti-vibration device in automobiles and transportation equipment, such as industrial transportation vehicles, such as an airplane, a forklift, a loading shovel, and a crane. The method of manufacturing a stabilizer bar with a rubber bush of the present disclosure may also be applied as a method of manufacturing a stabilizer bar with a rubber bush that can be used as an anti-vibration device to be used in other industrial machines.

### REFERENCE SIGNS LIST

1 stabilizer bar
2 portion to be fitted
3 rubber Bush
4 U-shaped outer peripheral surface
5 flat surface
13 first pressing tool
14 first fitting recessed portion
16 second pressing tool
17 second fitting recessed portion

1. A method of manufacturing a stabilizer bar with a rubber bush in which the stabilizer bar is inserted and held into the rubber bush, the method comprising:
a first step of manufacturing a rubber bush without an intermediate plate by subjecting a rubber composition containing butadiene rubber and natural rubber as a polymer to vulcanization molding;
a second step of applying a thermosetting adhesive onto at least one of an inner peripheral surface of the rubber bush and an outer peripheral surface of the stabilizer bar, to thereby form a thermosetting adhesive layer;
a third step of inserting and fitting the stabilizer bar into the rubber bush;
a fourth step of holding the rubber bush with a fixing jig such that the rubber bush is compressed in a direction of the stabilizer bar fitted into the rubber bush at a rate of 0% to 5%, at 25° C.; and
a fifth step of heating the rubber bush to cure the thermosetting adhesive, while holding the rubber bush with the fixing jig such that the rubber bush is compressed in the direction of the stabilizer bar fitted into the rubber bush at the rate of 0% to 5%, to thereby bond and fix the rubber bush onto the stabilizer bar.

2. The method of manufacturing a stabilizer bar with a rubber bush according to claim 1, wherein the rubber bush comprises a rubber composition containing butadiene rubber (BR) and natural rubber (NR) at a weight ratio BR/NR of from 4/6 to 1/9.

3. The method of manufacturing a stabilizer bar with a rubber bush according to claim 1, wherein the second step comprises applying an undercoat thermosetting adhesive onto the outer peripheral surface of the stabilizer bar and applying a topcoat thermosetting adhesive onto the undercoat thermosetting adhesive.

4. The method of manufacturing a stabilizer bar with a rubber bush according to claim 1, wherein the fixing jig covers an entire outer peripheral surface of the rubber bush.

5. The method of manufacturing a stabilizer bar with a rubber bush according to claim 1, wherein, in the fifth step, the rubber bush is heated at 150° C. to 180° C. for 1 to 2 hours.
